(19) United States
(12) Patent Application Publication
(10) Pub. No.: US 2012/0061284 A1
(43) Pub. Date: Mar. 15, 2012

(54) COMPOSITION USED FOR PREPARING CONCRETE WITHOUT ADDING WATER

(76) Inventors: Michel Pasquier, Lyon (FR); Damien Rogat, Villeurbanne (FR)

(21) Appl. No.: 13/141,401

(22) PCT Filed: Feb. 24, 2010
(86) PCT No.: PCT/FR2010/050312

§ 371 Date: Nov. 22, 2011

(30) Foreign Application Priority Data
Feb. 24, 2009 (FR) 09/51151

(51) Int. Cl. B65D 71/00; C04B 24/26; C04B 24/10; C04B 28/00; C04B 14/02

(52) U.S. Cl. 206/568; 106/638; 106/817; 106/804; 524/5

(57) ABSTRACT

The invention relates to a composition for preparing a liquid mortar or concrete without adding water, to a method for preparing said composition, and to a kit including said composition.

The present invention relates to a composition for the preparation of a liquid mortar or concrete without adding water, to a method for preparing said composition and to a kit comprising this composition.

Concrete is a material widely used for producing civil engineering structures and various constructions. Specifically, this is a product having two successive states: a plastic or fluid phase, enabling it to be processed by casting; then a hardening and strengthening phase, enabling it to achieve its mechanical performance in use.

Concrete commonly consists of a hydraulic binder, aggregates, water and optional admixtures. The water participates in the two successive phases of the life of concrete. It contributes to the formation of the plastic or fluid phase constituting a paste with the hydraulic binder and participates thereafter in the setting mechanisms that lead to the usage qualities of the colincrete.

The mechanisms involved in the setting of a hydraulic binder depend on the nature of the latter. In general, setting takes place via a succession of dissolving reactions and precipitations of new chemical species. These new chemical species, essentially crystals, grow and coalesce in such a way that they ensure, by their entanglement, continuity of the material, thus rigidifying it. This concatenation of reactions is commonly referred to as hydration.

Concretes are commonly produced using cements as hydraulic binders. The nature of these cements does not affect the general principles described above but it does determine the formulation rules and especially the amount of water used.

The amount of water used in the composition of a hydraulic concrete plays a crucial role in the quality of the concrete finally produced. Specifically, the final mechanical strength of the concrete is determined by the relative amounts of hydraulic binder and water. In general, the lower the water/binder ratio the higher the final strength. This ratio is usually written as W/C (mass ratio of water to cement). For a Portland cement of CEM I type according to the EN 197-1 standard, it is common practice to use it in cement compositions having a W/C ratio between 0.35 and 0.65.

The stoichiometric water requirements relating to setting are less than the requirements needed for obtaining a consistency suitable for processing the material. Thus, it is usually found that complete hydration of a CEM I cement requires a W/C equal to or greater than 0.2. The excess water makes it possible to obtain mortars or concretes that are sufficiently plastic or even fluid so as to be processed.

As a consequence, the amount of water participating in the formulation of a cement composition of the concrete, mortar or other type, plays an important role in determining the final quality thereof.

If the water is in excess, the final mechanical properties will be inferior to what might be expected. In particular, the strength of the product finally produced will be lower, its porosity will be higher, making it more sensitive to external chemical attack, and, in the fresh state, static and dynamic segregation will be observed.

In addition, the amount of water used may also have an impact on the performance of the product. This is particularly important in locations where water resources are limited.

It is therefore necessary to provide users with a mortar or a concrete that can be easily prepared, without the risk of excess water impairing the final quality of the concrete or without the risk of poor quality water being used.

Polymers referred to as “superabsorbents” are known for their capability of capturing water and retaining it. Patent application EP-A-0 338 739 describes the use of water trapped in a superabsorbent for the purpose of being added to an aggregate mixture for preparing mortars or concretes having a low water/cement (W/C) ratio. The addition of water trapped in a superabsorbent is presented as the way of remedying the difficulty of mixing mortars or concretes thus prepared or as a way of controlling the temperature or even controlling the loss of workability of mortars and concretes during the plastic phase. The above document makes no mention of the problem addressed by the present invention.

In “Water-entrained cement-based materials”, Cement and Concrete 2001, Vol. 31, No. 4, pp. 647-654, Ole Mejlhede Jensen et al. report the use of superabsorbent polymers which is described as a means of keeping the water inside a cement composition for the purpose of limiting desiccation.

Finally, in “Autogenous Shrinkage of Concrete with Super-Absorbent Polymer”, ACI Materials Journal, 2009, Vol. 106, No. 2, pp. 123-127, Fa-Zhou Wang et al. report the use of a superabsorbent polymer for reducing shrinkage in cements. However, the authors also report that the mechanical performance of the cements thus prepared is degraded.

It has now been found very surprisingly a composition that enables a concrete or mortar to be prepared without adding water, thus providing a satisfactory solution to the abovementioned technical problems, without the performance of the final materials obtained being degraded. By virtue of this composition, the end user will not in fact need to worry about the quality and/or the amount of water necessary for preparing the mortar or concrete.

Thus, the present invention relates to a composition of divided solid form, comprising:
an aggregate mixture;
a superabsorbent; and
water.

The composition according to the invention makes it possible, by the addition of a mix in the form of a cement powder and admixtures, and without addition of water, to prepare a liquid mortar or concrete. It has in fact been observed, very surprisingly, that the water contained in the composition according to the invention entered the superabsorbent spheres and remained stably therein until it was released upon contact with the mixture of cement and admixtures, thus giving the concrete its plasticity.

In the context of the present invention, the expression “aggregate mixture” is understood to mean a mixture of natural or artificial aggregates of different granular classes, the relative proportions of which allow the production of concrete or mortar in accordance with the formulation rules known to those skilled in the art. The aggregates and the terms used are described by the NF EN 12620+A1:2008-06 standard. Preferably, the aggregate mixture comprises sand, fine gravel and coarse gravel and may optionally contain fines. The various granular classes may be of the rounded, semi-crushed or crushed type of any petrographic nature. For advantageously carrying out the invention, aggregates of silico-calcareous type are preferred.

In addition, in the context of the present invention, the term “superabsorbent” is understood to mean any crosslinked polymer capable of absorbing up to 1000 times its weight of water. Superabsorbent polymers are commonly used in the body hygiene field. They essentially consist of long crosslinked hydrophilic chains giving them a high affinity for water while being completely insoluble owing to their three-dimensional structure. This particular characteristic enables them to be swollen with water while not being dispersed therein. As examples of such polymers, the following may be mentioned: crosslinked acrylic acid/sodium acrylate copolymers, polyvinyl alcohols and grafted products based on natural, modified natural or synthetic polysaccharides. Crosslinked acrylic acid/sodium acrylate copolymers that make it possible to achieve very high degrees of water absorption may preferably be mentioned.

Finally, in the context of the present invention, the proportions expressed in % correspond to percentages by weight relative to the total weight of the composition in question.

Preferably, the composition according to the invention comprises:
80 to 95% of an aggregate mixture;
0.005 to 1% superabsorbent; and
1 to 20% water.

More preferably, the composition according to the invention comprises:
85 to 93% of an aggregate mixture;
0.01 to 0.5% superabsorbent; and
5 to 10% water.

Even more preferably, the composition according to the invention is free of any admixture. In the context of the present invention, the term “admixture” is understood to mean any chemical substance or a mixture of chemical substances capable of modifying the performance of the mortar or concrete in the fresh state or in the hardened state.

The invention also relates to a process for preparing the composition as described above, comprising the following steps:
dry-blending of the aggregates and superabsorbent beads;
introduction of the mixing water; and
mixing until a homogeneous mix in divided solid form is obtained.

The present invention also relates to the various products prepared from the composition, particularly concretes and mortars. Thus, another subject of the present invention is a concrete or mortar comprising the composition according to the invention.

The present invention also relates to a kit useful for preparing a concrete or a mortar without adding water, said kit comprising:
a composition of divided solid form according to the invention; and
a mix in the form of cement powder and one or more admixtures.

In the context of the present invention, the cements used are of the family of Portland cements, calcium aluminate cements, sulfo-aluminous cements and prompt natural cements.

Preferably, the admixtures used in the kit are chosen from chemical substances or a mixture of chemical substances capable of modifying the performance of the mortar or concrete in the fresh state or in the hardened state. They generally consist of organic or inorganic molecules, possibly in salt form. Optionally, they may be water-soluble polymers, whether functionalized or not. More preferably, the admixtures used in the kit are chosen from products described in the EN 934-2 standard defining the admixtures for mortars and concretes. Preferably, the admixtures used will be chosen from superplasticizers or strong water reducers of the polycarboxylate, sulfonated polymelamine, lignosulfonate and polynaphthalene sulfonate type.

The admixtures used in the kit are in powder form (not in solution in water) so as to be able to be mixed with the cement without causing hydration reactions.

Preferably, the kit according to the invention takes the form of a bag having two compartments:
the hermetically sealed first compartment containing the composition according to the invention; and
the second compartment contains a mix in the form of cement powder and one or more admixtures.

Such a bag may for example be prepared in the following manner:
dry-blending of the aggregates and superabsorbent beads;
introduction of the mixing water;
mixing until a homogeneous mix is obtained;
introduction of the mix into the first compartment of the bag and hermetically sealing it so as to prevent any water evaporation; and
introduction of the cement and optionally of the admixtures in powder form into the second compartment and hermetically sealing it.

Finally, the present invention also relates to the various products prepared from the kit described above, particularly concretes and mortars. Thus, the subject of the present invention is also the use of the kit described above for preparing a concrete or a mortar.

The present invention may be illustrated in a non-limiting manner by the following examples.

### EXAMPLE 1

Three concretes of C30/37 XF1 S2 D11 class according to the EN206-1 standard were produced from kits containing the following constituents:

| | Control kit | | Kit 1 | | Kit 2 | |
|---|---|---|---|---|---|---|
| Constituents | kg/m³ | wt % | kg/m³ | wt % | kg/m³ | wt % |
| Compartment A | | | | | | |
| Perrin 0/4R sand | 997 | 47.887 | 997 | 47.887 | 997 | 47.887 |
| Faverges | 928 | 44.573 | 928 | 44.573 | 928 | 44.573 |
| Gr 4/11.2 RL | | | | | | |
| Norsocryl D60 | — | — | 1 | 0.048 | 0.75 | 0.036 |
| Total Water | 157 | 7.541 | 157 | 7.541 | 157 | 7.541 |
| Compartment B | | | | | | |
| Vicat Montalieu | 350 | 99.7009 | 350 | 99.7009 | 350 | 99.7009 |
| CEM 11/A LL | | | | | | |
| 42.5 R cement | | | | | | |
| Peramin LP 170 | 1.05 | 0.2991 | 1.05 | 0.2991 | 1.05 | 0.2991 |

The composition contained in compartment A of the control kit contained no superabsorbent. To prepare the concrete from this kit, an addition of water was necessary. This control kit served to measure the impact of the superabsorbent on the performance of the concrete finely prepared, both in the fresh state and in the hardened state.

Kits 1 and 2 were produced in accordance with the invention: to prepare the concrete from these kits, no additional water was necessary. They consisted of two sealed compartments.

The composition introduced into compartment A took the form of a divided solid obtained by blending the aggregate (0/4 sand and 4/11 gravel) and then mixing this with the crosslinked sodium polyacrylate superabsorbent with the trade name Norsocryl D60 from the company Arkema and the water.

Introduced into compartment B was a mixture of cement (Vicat Montalieu CEM II/A LL 42.5 R) and the polycarboxylate superplasticizer, with the trade name Peramin LP 170 from the company Peramin SA in powder form.

The compartments were watertight sealed pockets made of a plastic making it possible to preserve the two mixtures: to keep the water in compartment A and to keep the cement dry in compartment B.

For each trial, the two pockets were opened and their contents mixed.

After a few moments, the mixture of the two powder materials was converted to a plastic concrete, the performance in the fresh state and in the hardened state was measured. The results obtained are given in the following table:

| | Concrete | | | | | | | | | | | |
|---|---|---|---|---|---|---|---|---|---|---|---|---|
| Measured | prepared from the | | | | Concrete prepared | | | | Concrete prepared | | | |
| performance | control kit | | | | from kit 1 | | | | from kit 2 | | | |
| Time (min) | 0 | 30 | 60 | | 0 | 30 | 60 | | 0 | 30 | 60 | |
| Slump (mm): | 140 | 80 | 50 | | 30 | 10 | 10 | | 40 | 10 | 10 | |
| EN12350-2 | | | | | | | | | | | | |
| Density | 2338 | | 2368 | | 2370 | | 2381 | | 2380 | | 2395 | |
| (kg/m³): | | | | | | | | | | | | |
| EN12350-6 | | | | | | | | | | | | |
| Occluded air | 4.6 | | 4.7 | | 4.4 | | 4.2 | | 3.5 | | 3.4 | |
| (%) EN123507 | | | | | | | | | | | | |
| At day | 1 | 2 | 7 | 28 | 1 | 2 | 7 | 28 | 1 | 2 | 7 | 28 |
| R_{c} (MPa): | 15 | 25 | 36 | 42 | 14 | 23 | 32.5 | 38.5 | 15.5 | 23.5 | 34 | 39.5 |
| EN12390-3 | | | | | | | | | | | | |
| % R_{c} loss/ | | | | | 6.7 | 8.0 | 9.7 | 8.3 | −3.3 | 6.0 | 5.6 | 6.0 |
| nominal R_{c} | | | | | | | | | | | | |
| R_{crack} (MPa): | | | | 3.9 | | | | 3.8 | | | | 4 |
| EN12390-3 | | | | | | | | | | | | |
| Shrinkage | | −57 | −157 | −315 | | −62 | −146 | −306 | | −68 | −153 | −322 |
| (μm/m): | | | | | | | | | | | | |
| NFP18427 | | | | | | | | | | | | |

The tests for measuring slump carried out according to the EN12350-2 standard serve to characterize the consistency of the concrete. The higher the value, the more plastic or even fluid the concrete.

The tests for measuring the density according to the EN12350-6 standard serve to characterize the overall quality of the concrete in the fresh state.

Likewise, the measurement of the occluded air according to the EN12350-7 standard serves to check the amount of air entrained in the formulation of the concrete during mixing. The higher the occluded air value, the lower the long-term strength of the concrete. However, the occluded air may allow frost-resistant concretes to be formulated.

The compressive strength (R_{c}) and the crack resistance (R_{crack}) measured according to the EN12390-3 standard serve to characterize the mechanical performance of the concrete in the short, medium and long term (2, 7 and 28 days).

The shrinkage, measured according to the NFP18427 standard, serves to characterize the contraction of the mortar or concrete as it sets and its strength rises.

Thus, it should be noted that the superabsorbent increases the consistency of the concrete (slump test) and has no significant effect on the other tests in the fresh state, namely the density and the occluded air.

In the hardened state, there is a slight loss of performance in respect of compressive strength, without other performance characteristics being degraded. This loss may be compensated for by a slight overdose of cement.

### EXAMPLE 2

Three mortars were produced from kits containing the following constituents:

| | Control kit | | Kit 1 | | Kit 2 | |
|---|---|---|---|---|---|---|
| Constituents | kg/m³ | wt % | kg/m³ | wt % | kg/m³ | wt % |
| Compartment A | | | | | | |
| 0/4 sand | 1566 | 88.7 | 1566 | 88.637 | 1566 | 88.612 |
| Norsocryl D60 | — | — | 0.75 | 0.042 | 1.25 | 0.071 |
| Total Water | 200 | 11.3 | 200 | 11.320 | 200 | 11.317 |
| Compartment B | | | | | | |
| Vicat Montalieu | 400 | 63.37 | 400 | 63.37 | 400 | 63.37 |
| CEM II/A LL | | | | | | |
| 42.5 R cement | | | | | | |
| OMYA GY | 230 | 36.44 | 230 | 36.44 | 230 | 36.44 |
| Betocarb P2 | | | | | | |
| BASF Melflux | 1.20 | 0.19 | 1.20 | 0.19 | 1.20 | 0.19 |
| 2651 F | | | | | | |

The composition contained in compartment A of the control kit contained no superabsorbent. To prepare the mortar from this kit, an addition of water was necessary. This reference kit serves to measure the impact of the superabsorbent on the performance of the concrete finally prepared, both in the fresh state and in the hardened state.

Kits 1 and 2 were prepared like the kits of example 1.

For each test, the two pockets were opened and their contents mixed.

After a few moments, the mixture of the two powder materials was transformed into a plastic mortar, the performance of which, both in the fresh state and in the hardened state, is given in the following table:

| | Mortar prepared | | | | | | | | | | | |
|---|---|---|---|---|---|---|---|---|---|---|---|---|
| Measured | from the control | | | | Mortar prepared | | | | Mortar prepared | | | |
| performance | kit | | | | from kit 1 | | | | from kit 2 | | | |
| Time (min) | 0 | 30 | 60 | | 0 | 30 | 60 | | 0 | 30 | 60 | |
| Slump (mm): | 210 | 160 | 120 | | 180 | 100 | 50 | | 160 | 50 | | |
| EN12350-2 | | | | | | | | | | | | |
| Density | 2268 | | 2284 | | 2265 | | 2283 | | 2272 | | | |
| (kg/m³): | | | | | | | | | | | | |
| EN12350-6 | | | | | | | | | | | | |
| Occluded air | 4.8 | | 5.4 | | 5.8 | | 5.2 | | 6 | | | |
| (%) EN12350-7 | | | | | | | | | | | | |
| At day | 1 | 2 | 7 | 28 | 1 | 2 | 7 | 28 | 1 | 2 | 7 | 28 |
| R_{c} (MPa): | 20.5 | 29.5 | 38.5 | 48 | 17.5 | 25 | 31 | 42 | 19 | 27 | 36.5 | 46.5 |
| EN12390-3 | | | | | | | | | | | | |
| R_{crack} (MPa): | | | | 3.9 | | | | 3.8 | | | | 3.8 |
| EN12390-3 | | | | | | | | | | | | |
| Shrinkage | | −68 | −246 | −397 | | −79 | −184 | −318 | | −55 | −202 | −365 |
| (μm/m): | | | | | | | | | | | | |
| NFP18427 | | | | | | | | | | | | |

It will be noted that the superabsorbent increases the consistency of the concrete (slump test) and has no significant influence on the other tests in the fresh state: density and occluded air.

In the hardened state, a slight loss of performance in respect of the compressive strength is noted, without the other performance characteristics being degraded. This loss may be compensated for by a slight overdose of cement.

### EXAMPLE 3

Four concretes of C30/37 S4 D22.4 class according to the EN206-1 standard were produced from kits containing the following constituents:

| | Constituents | | | |
|---|---|---|---|---|
| | Control | Kit 1 | Kit 2 | Kit 3 |
| | kg/m³ | kg/m³ | kg/m³ | kg/m³ |
| Compartment A | | | | |
| St Jean le Vieux 0/4Scl | 748 | 748 | 748 | 748 |
| sand | | | | |
| Faverges Gr 4/11.2 RL | 310 | 310 | 310 | 310 |
| Faverges Gr 11.2/22.4 RL | 721 | 721 | 721 | 721 |
| Norsocryl D60 | — | 0.93 | 0.86 | 1.5 |
| Total water | 195 | 195 | 195 | 195 |
| Compartment B | | | | |
| Vicat Montalieu CEM I | 350 | 350 | 350 | 350 |
| 52.5N PM cement | | | | |

The composition contained in compartment A of the control kit contains no superabsorbent. To prepare the mortar from this kit, an addition of water was necessary. This reference kit serves to measure the impact of the superabsorbent on the performance of the concrete finally prepared, both in the fresh state and in the hardened state.

Kits 1, 2 and 3 were prepared like the kits of example 1.

For each test, the two pockets were opened and their contents mixed.

After a few moments, the mixture of the two powder materials was converted into a plastic mortar, the performance of which, both in the fresh state and in the hardened state, are given in the following table:

| | Concrete | | | |
|---|---|---|---|---|
| | prepared | Concrete | Concrete | Concrete |
| | from the | prepared | prepared | prepared |
| Measured performance | control kit | from kit 1 | from kit 2 | from kit 3 |
| Time (min) | 0 | 0 | 0 | 0 |
| Slump (mm): EN12350-2 | 210 | 210 | 210 | 200 |
| Density (kg/m³): | 2439 | 2387 | 2395 | 2393 |
| EN12350-6 | | | | |
| Occluded air (%): | 0.5 | 0.8 | 0.8 | 1.1 |
| EN12350-7 | | | | |
| At day | 7 | 7 | 7 | 7 |
| R_{c} (MPa): EN12390-3 | 31.5 | 28.5 | 30 | 31.5 |

It should be noted that the use of a CEM I cement serves to maintain a stable consistency despite the amount of superabsorbent in the composition and that the performance in the hardened state is unaffected.

1. A composition of divided solid form, comprising:
an aggregate mixture;
a superabsorbent; and
water.

2. The composition as claimed in claim 1, characterized in that the aggregate mixture comprises sand, fine gravel and coarse gravel.

3. The composition as claimed in claim 1, characterized in that the superabsorbent is chosen from crosslinked acrylic acid/sodium acrylate copolymers, polyvinyl alcohols and grafted products based on natural, modified natural or synthetic polysaccharides.

4. The composition as claimed in claim 1, characterized in that it comprises:
80 to 95% of an aggregate mixture;
0.005 to 1% superabsorbent; and
1 to 20% water.

5. The composition as claimed in claim 1, characterized in that it is free of an admixture.

6. A process for preparing a composition as claimed in claim 1, comprising the following steps:
dry-blending of the aggregates and superabsorbent beads;
introduction of the mixing water; and
mixing until a homogeneous mix in divided solid form is obtained.

7. A concrete comprising a composition as claimed in claim 1.

8. A mortar comprising a composition as claimed in claim 1.

9. A kit useful for preparing a concrete or a mortar without adding water, said kit comprising:
a composition as claimed in claim 1; and
a mix in the form of cement powder and one or more admixtures.

10. The kit as claimed in claim 9, characterized in that it is in the form of a bag having two compartments:
the hermetically sealed first compartment containing a composition as claimed in claim 1; and
the second compartment contains a mix in the form of cement powder and one or more admixtures.

11. The kit as claimed in claim 9, characterized in that the admixtures used are chosen from superplasticizers or strong water reducers of the polycarboxylate, sulfonated polymelamine, lignosulfonate and polynaphthalenesulfonate type.

12. Use of the kit as claimed in claim 9 for preparing a concrete or a mortar.
